(19) United States
(12) Patent Application Publication
(10) Pub. No.: US 2015/0152318 A1
(43) Pub. Date: Jun. 4, 2015

(54) FRACTURING PROCESS USING LIQUID AMMONIA

(71) Applicant: EOG RESOURCES, INC., Houston, TX (US)

(72) Inventor: Gary Lee TRAVIS, Aransas Pass, TX (US)

(73) Assignee: EOG RESOURCES, INC., Houston, TX (US)

(21) Appl. No.: 14/556,806

(22) Filed: Dec. 1, 2014

Related U.S. Application Data
(60) Provisional application No. 61/963,332, filed on Dec. 2, 2013.

(51) Int. Cl. C09K 8/68; E21B 27/02; C09K 8/80; E21B 43/267

(52) U.S. Cl. CPC C09K 8/685; E21B 43/267; E21B 27/02; C09K 8/80

(57) ABSTRACT

A fracturing fluid that includes the combination of liquid ammonia and a proppant, and a method for fracturing an underground formation by pumping this fracturing fluid into a wellbore that extends to the formation. The process includes generating pressure in the wellbore, creating fractures in the formation using the liquid or gelled ammonia and proppant slurry, and releasing pressure from the wellbore. The ammonia released from the liquid or gelled ammonia helps stabilize clays in the formation and the proppant helps to maintain the fractures in the formation.

### CROSS-REFERENCE TO RELATED APPLICATION

This application claims the benefit of U.S. provisional patent application No. 61/963,332 filed on Dec. 2, 2013, the entire content of which is incorporated herein by reference thereto.

### FIELD OF THE INVENTION

The present invention relates to a process for fracturing (or “fracking”) a targeted formation in a petroleum exploration or development well, and in particular, to methods and compositions for fracturing a well using fracturing fluid formulations comprising liquid ammonia and proppants. More particularly, the invention relates to fracturing fluid formulations comprising gelled or crosslinked ammonia liquid, which allows for higher viscosity and thus increased proppant volume in the fluid, as well as additives that may be suitable for the particular formation conditions.

### BACKGROUND OF THE INVENTION

Hydraulic fracturing is a technique of fracturing subsurface rock formations with a pressurized fluid, usually water mixed with sand and chemicals, in order to extract oil and natural gas contained in the formations. The fracturing fluid is injected into a wellbore under pressure to create fractures in the target formations. Water is essentially incompressible, therefore it is effective at fracturing the rock in the formation. When the pressure is lowered in the wellbore, the sand props the fractures open allowing the oil and gas contained in the formations to more readily flow into the well for extraction. This technique has revolutionized oil and gas development, especially in shale formations but also in sands and in other tight formations, because it permits extraction of formerly inaccessible hydrocarbons. As a result, it has helped push U.S. oil production to a new high and generates billions of dollars of revenue to mineral rights owners and oil companies, as well as federal, state, and local governments.

Another reason water is commonly used as a fracturing fluid is because water is inexpensive and has generally been readily available. However, large volumes of water are necessary and often times must be transported over great distances. After the well is fractured, the water that returns to the surface under pressure contains fracturing chemicals and other substances carried away from the formations, such as salts and metals. The fluid thus requires disposal, or treatment and removal of contaminants and non-water components, before the fluid can be reused or put back into natural water bodies. In certain clay types, e.g., smectites, water can also cause swelling, blocking the pores and reducing hydrocarbon productivity. Water can also react with the minerals, salts, and native water and hydrocarbons down-hole, resulting in reservoir contamination. Moreover, in areas or at times where there are drought conditions, low water supplies, or restricted water use, water may be scarce making it a less than ideal source. Accordingly, having a fracturing fluid that requires less or no water, or less treatment, would be beneficial.

In addition, in formations that are high in clay content, water in the fracturing fluid can cause the clay/sand interfaces to slip, and the clays to swell, which can damage the formation causing flowback and potentially formation collapse. For example, certain sand formations along the South Texas coast have a history of formation flowback and casing collapse when fracked. Water injected during fracking can cause the release of clays from the matrix substrate and attachment of the released clay particles through van der Waals forces, resulting in the binding of clay platelets or flocculation. When this flocculation occurs, the pore throat may be partially or completely plugged, reducing production rather than stimulating it. This plugging effect is more pronounced in lower permeability sands and shales with high clay content.

Clay particles are typically layers of silica tetrahedrons (SiO₄) and aluminum octahedrons (Al(OH)₆) in 2:1 layers, respectively. The face of a clay particle is negatively charged due to isomorphic substitution, for example; Al⁺³ for Si⁺⁴ in the tetrahedrons and Mg⁺² for Al⁺³ in the octahedrons. Surrounding each clay particle is a cloud of cations. This is the diffuse double layer (DDL) also called an electric double layer (EDL) or a Gouy-Chapman layer. The radius of the DDL is controlled by the salinity of the solution around the particle. The radius will be larger in less saline water as the cations diffuse out into a less saline environment. In a higher salinity, the DDL will have a smaller radius. Likewise, in a more acidic environment, the protons in the aqueous environment cause the cation cloud around the clay particle to contract.

A high saline and/or low pH environment also causes clay particles to release from the substrate due to their attraction to migrating clay particles and aggregates. Typical fracturing fluid is high salinity in order to prevent swelling, in part because Na⁺ and other cations would not diffuse into the high salinity water. Lab tests have shown lower losses in permeability with high salinity fluid, and lab tests have also shown loss of permeability when low salinity fluid is flushed through a pore. However, an increase in cations in the pore throat associated with using high salinity fluids can cause flocculation. On the other hand, using a low salinity fluid is not recommended because swelling will occur in part because of the detachment of clay particles from the pore walls. The aspect ratio of clay particles makes them too large to fit through tight sands and shale pore throats resulting in loss of flow.

A further consideration for clay formations is that guar or xanthan gum are fracturing fluid additives that have polarity and thus can cause clay flocculation by shrinking the cloud of cations associated with negatively charged clays. To reduce the resulting clay flocculation, clay stabilizers are often added to the stimulation fluid. However, the surface area of all the contacted clay particles may be so large that clay stabilizer additives cannot prevent flocculation. As such, in certain clay/sand formations, an alternative liquid carrier for the proppant is desirable, one that will be less reactive with the clays.

Alternative carrier fluids have been proposed and tested, such as liquified petroleum gas (LPG), typically a mixture of propane and butane, or carbon dioxide. However, the use of LPG as a fracturing fluid is disadvantageous due to its relatively high cost. A further drawback of LPG is that it changes the heat value as well as other important quality specifications of the product gas that is recovered. Carbon dioxide also requires significantly greater expense when it is introduced as a cryogenic liquid or supercritical fluid, in part because of the additional and costly handling that is required. Furthermore, carbon dioxide can generate scale when mixed with in situ water present in the formation, and this can cause clay particle flocculation, flow back, or possible collapse of the formation and damage to the well bore or casing.

Accordingly, there is a need for an improved hydraulic fracturing fluid formulation and method for use in fracking a wellbore formation.

### SUMMARY OF THE INVENTION

The invention provides a fracturing fluid comprising liquid ammonia, which may be gelled or crosslinked, and a proppant. The proppant is present in an amount and size sufficient to help maintain or keep an induced hydraulic fracture open during or following a fracturing treatment of an underground formation. The proppant also serves to divert fracturing fluid in additional directions to increase the complexity of the fracture network. When the liquid or gelled ammonia reacts with water in the reservoir, ammonium hydroxide is formed which helps stabilize clays and remove water in the underground formation.

The liquid and/or gelled ammonia is preferably anhydrous and is preferably present in an amount of at least 25% by weight of the fracturing fluid. Typically, the proppant is an inorganic particulate material present in an amount of at least 3% by weight of the fracturing fluid. Preferably, the gelled ammonia may be present in an amount of 25% to 96% by weight of the fracturing fluid while the proppant may be present in an amount of at least 3% to 70% by weight of the fracturing fluid.

In some embodiments, the fracking fluid formulations contain a polymer, a surfactant, or a clay as the gelling agent. In addition, the fracturing fluid can further comprise one or more additives selected for assisting in the use of the fracturing fluid for fracking for specific formulations or wellbore conditions.

The invention also relates to a method for fracturing an underground formation which comprises pumping a fracturing fluid into a wellbore that extends to the formation, the fracturing fluid comprising gelled ammonia and a proppant. Generating fracturing fluid pressure in the wellbore creates fractures in the formation and when pressure is released permeability and increased hydrocarbon flow from the wellbore result.

### BRIEF DESCRIPTION OF THE DRAWINGS

For the purposes of illustrating the present invention, there is shown in the drawings a schematic form of a system which is presently preferred, it being understood, however, that the invention is not limited to the precise form shown by the drawing in which:

FIG. 1 shows a schematic drawing which shows the general arrangement of the ammonia, proppant, additives, pumps and mixer for use in fracking a well with a liquid ammonia formulation according to the present invention.

### DETAILED DESCRIPTION OF THE INVENTION

The invention as set forth herein is a composition and a procedure for stimulating (fracturing) a formation penetrated by a well bore through the use of liquid ammonia and proppants as a fracturing fluid. The procedure's goal is to enhance production of in situ hydrocarbon fluids, typically oil, condensate, and natural gas, with the smallest reduction in formation permeability.

Ammonia is an abundant, relatively low cost chemical that is part of nature's nitrogen cycle being synthesized from nitrogen and hydrogen. It has an equivalent weight of 17 and is a stable and colorless gas at standard atmospheric pressure and temperature. When compressed, ammonia forms a colorless liquid with approximately 60% the density of water. Ammonia is typically stored in vessels under pressure at 114 psig and 70 degrees Fahrenheit at a concentration of 5.08 pounds per gallon. Liquid ammonia has a boiling point of 28 degrees Fahrenheit, a freezing point of −107 degrees Fahrenheit, and a critical temperature of 132 degrees Fahrenheit. It is a biologically active compound present in most waters as a normal degradation component of nitrogenous organic matter. Thus, ammonia is a reliable and cost effective source for carrying proppant in a fracturing fluid composition. The invention provides ammonia in a liquid state as a proppant carrier to provide significant advantages over the use of water or other fluids.

The use of liquid ammonia in place of other common proppant carrying fluids is desirable because the ammonia does not have an adverse reaction on the subterranean rock components and can increase permeability or at minimum does not result in harmful permeability reduction. Ammonia is polar, allowing it to displace water. Additionally, in clay formations, the use of liquid ammonia reduces or eliminates some of the causes of slippage, flocculation, and formation collapse. In the reservoir, ammonia will react with water and form ammonium hydroxide. The hydroxide combines with cations diffusing away from the fracture face to prevent or reduce flocculation and avoid decreasing permeability after the stimulation is complete. The hydroxide also combines with released Ca++ cations to form calcium hydroxide which helps stabilize the clay. The ammonium also helps stabilize the clays, and reduces scaling potential in the pore throat by causing carbonates, phosphates, and sulfides to be soluble.

The liquid ammonia mixture is capable of carrying solid particles which are used as proppant and diverting agent. Proppant is added to the liquid ammonia mixture to prevent the fractures from closing completely after the stimulation process is completed. The invention may include gelling or crosslinking agents, as discussed below, which gel the liquid ammonia and increase the proppant carrying capacity of the fluid.

The liquid ammonia may be prepared by a variety of techniques. One way is to compress gaseous ammonia under a suitable pressure to cause liquification. This can be accomplished by subjecting the ammonia to a pressure of at least 150 psi in a suitable vessel at a temperature of between 60 and 70 degrees Fahrenheit. It is also possible to achieve a liquid or gelled state by passing the compressed mixture through a pipe that has suitable static elements therein that cause the liquid to be mixed into a gel. The pressure to be used is based on the formation strength, the desired geometry of the fracture and the friction pressure. For deep wells, the ammonia fracturing fluid could be pumped at pressures as high as 20,000 psi, with higher pressures generally requiring lower processing temperatures. Preferably the liquid ammonia is anhydrous or at least does not contain any significant amounts of water, most preferably less than 1%. Certain copper alloys or brass components should be avoided in such pumping equipment and piping, as they react with the ammonia but steel or stainless steel components are entirely suitable.

A gelled ammonia may also be prepared by adding a gelling agent to the liquid ammonia. The gelling agent can be many different polymers that hydrate or swell when mixed with the liquid ammonia to form a viscous gel, or one or more surfactants such as, for example, various gums that increase the rheology and viscoelastic properties. The preferred gelling agent could include components such as the typical guar and its derivatives (hydroxypropyl guar, carboxymethyl hydroxypropyl guar, etc.) and non guar-based gelling agents (hydroxyethyl cellulose), xanthan and polysaccharides, etc. The amount of gelling agents can range from several pounds per thousand gallons up to about 50 pounds per thousand gallons depending upon the specific agent that is used. The gelled ammonia mixture can have a viscosity of between 5 and 300 cps which renders it suitable for pumping through conventional pumps and fluid handling equipment, but viscous enough to retain sufficient proppant.

Conveniently, the proppant can be added to the liquid ammonia during the gelation process. The relative amount of ammonia and proppant, by weight, can vary over a wide range. Typically, the amount of ammonia is at least 25% by weight of the overall mixture that is used for fracking, but it can be as high as 96%. The remainder of the mixture is primarily proppant although small amounts of other additives may be present. In the most general sense, the proppant is present in an amount of about 3% to as much as 70% in the fracking mixture, with the remaining percentage of about 1 to 10% being other additives.

The suitable proppant is any solid material, typically inorganic and oil-insoluble, that can be carried by the gelled ammonia and that can help maintain or keep an induced hydraulic fracture open, during or following a fracturing treatment. The proppant used should have a sufficiently large interstitial space between particles along with the mechanical strength to withstand closure stresses to hold fractures open after the fracturing pressure is withdrawn. The proppant may be chosen from sand, ceramic, bauxite, glass, impregnated sand or many other oil-insoluble materials sufficient to prop open the fractures in the formation. Typically, treated sand or ceramic materials are preferred. To reduce fines during handling, these inorganic materials may be coated with a polymeric resin. Also, a proppant flowback control agent such as fibers may be included. The proppant can be present in concentrations up to about 15 pounds per gallon or more. The pounds per gallon can be varied throughout the stimulation procedure with some stages containing lesser amounts or even no proppant, i.e., pre-pad, pad and flush.

Alternatively, liquid ammonia may be gelled by initially forming an ammoniated dispersion of colloidal clay and incorporating into the dispersion a quantity, sufficient to thicken the dispersion, of a soluble source of at least one divalent or trivalent ion preferably selected from the group consisting of Mg++, Ca++, Ba++ and Al+++. The preferred amount of colloidal clay for use in producing gelled ammonia is from about 1% to about 20%, based on the weight of the gel composition.

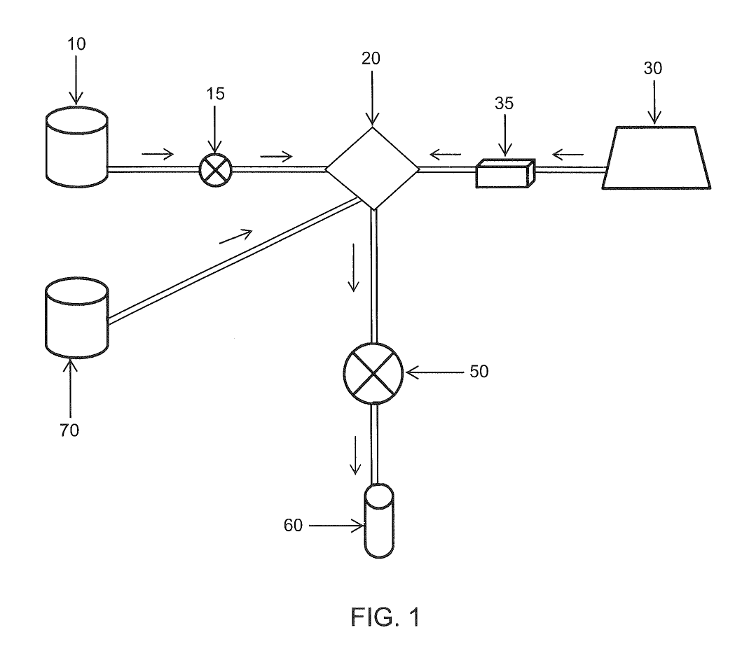

As shown in the schematic of FIG. 1, the liquified ammonia may be located at the well site, or in proximity to the well site, within a surface vessel 10 at a pressure and temperature sufficient to hold gaseous ammonia in a liquid state. The gelling agent may be added to liquid ammonia with various mixing temperature degrees, and mixed by a rotating agitator in vessel 10, blender 20, or other suitable device at an appropriate blending speed in a preparation vessel. Pump(s) 15 transfer the liquid ammonia maintain suitable pressure to the blender 20. The mixture can be pressurized to assist in preparing the gelled mixture. Gelled ammonia is obtained and removed from the vessel after an appropriate mixing time which typically varies between 20 and 40 minutes. The proppant 30 is also stored in proximity to the well site, and can be transported to the blender 20 or other mixing device by auger 35 or other conveyor and added to the liquid ammonia along with, or prior to, the addition of a gelling or crosslinking agent. Proppant 30 can be added to a “mixing tub” leading to the blender 20 at the required concentration for each stage of the process. Alternatively, the proppant can be added to the gelled ammonia prior to pumping the mixture. The mixture or slurry of liquid or gelled ammonia and proppant is transferred using transfer pumps to high pressure tri-plex pump(s) 50. The tri-plex pump(s) 50 pump the high pressure fluid to the wellhead 60 through a treating line(s) and from the wellhead 60 the fluid is pumped down the well, either in casing or tubing and into the formation for fracturing the underground formation. Fluids, foaming agents, and other additives 70 can also be added to the formulation at any point along the surface flow path and mixed prior to pumping the fluid downhole or during the course of the fracturing procedure. The shear, mixing and agitation necessary to disperse and maintain dispersion of the ammonia, additives and proppant in the mixture is produced by the turbulence in the well tubulars while being pumped to the formation.

The gelled liquid mixture is substantially anhydrous in order to keep water out of the subterranean formation and prevent swelling of water sensitive clays and other hydrophobic particles that may be contacted by the mixture. The ammonia mixture maintains a basic pH (>7 pH) which prevents the flocculation of clay particles which occurs in other situations where water or carbon dioxide are pumped and the pH is acidic. The hydroxide OH⁻ anion in solution will result in a higher pH which allows the cation DDL around the clay particles to expand and prevent clay flocculation. The ammonia mixture will not form scale as can occur when carbon dioxide mixes with in situ water present in the formation. The ammonia causes the clay particles to maintain stability and attachment to rock substrate which reduces the likelihood of clay particle flocculation and flow back and the possible subsequent collapse of the formation and damage to the well bore or casing.

The gelled ammonia is pumped into the formation at a pressure effective to create fracture in the rock with dimensions that are based on pump rate and fluid characteristics. The stable foam rheology is maintained for a half-life greater than or equal to the time required for the fracture treatment. This process can create multiple fractures through multiple perforated intervals in the casing and can have diverting agents added to the fluid to create diversion into multiple completion intervals. In the formation, the gelled ammonia will be heated by the ambient rock temperature to a temperature greater than the critical temperature of ammonia which can result in the formation of stable foam maintaining sufficient viscosity to carry proppant. When pumping is discontinued at the surface and the pressure is released, a substantial portion to all of the liquid ammonia vaporizes and is generally absorbed or adsorbed by the formation. If ammonia gas returns to the surface, it can be collected and flared.

Depending on the type of well treatment fluid utilized, various additives may also be added to the fracturing fluid to change the physical properties of the fluid or to serve a certain beneficial function. Leak off additives can be added to the mixture to prevent loss of fluid to the formation and screen-out of the fracture with proppant. Also, fluid loss agents may be added to partially seal off the more porous sections of the formation so that the fracturing occurs in the less porous strata. Other oilfield additives that may also be added to the fracturing fluid include emulsion breakers, antifoams, scale inhibitors, hydrogen sulfide or oxygen scavengers, crosslinking agents, surface tension reducers, breakers, buffers, fluid loss additives, temperature stabilizers, diverting agents, paraffin/asphaltene inhibitors, corrosion inhibitors, and biocides. In certain embodiments, other specific additives that may be incorporated with the liquid or gelled ammonia include:

1. Natural or synthetic hydratable polymers, alky groups (diethanol amines, amine oxides, quaternary amines, etc.), Sulfate groups (sulfated alkoxylates), ethyoxlyated linear alcohols, betaines. These can be added in an amount of up to about 5%.

2. Hydrocarbon components consisting of, but not limited to, light crude oil or condensate, jet or diesel fuel, kerosene, gasoline, natural gas liquids (ethane, propane, butanes, pentanes, and hexanes (C2-C6 compounds)). These can be added in an amount of up to about 85% (hydrocarbon-ammonia (ammonium) fracturing with ammonia as clay additive.

3. Ethylene glycol can be present for stability. This may be added in an amount of up to about 10%.

4. An inhibitor which acts to retard the hydration rate and thereby cause the increase in fluid viscosity to be delayed can be present in the mixture. This helps reduce viscosity and thereby reduce the required horsepower/pressure to pump the fluid into the formation. These can be added in an amount of up to about 20 gallons per thousand.

5. Crosslinking fluids or complexing agents such as multivalent metals can be added to the mixture in order to increase the proppant carrying capacity of the mixture. When used, these are typically present in an amount of up to about 10%.

6. Gases or liquified gas such as nitrogen and carbon dioxide can be included. Carbon dioxide is typically added as a liquid while nitrogen is typically added as a gas. The amounts of these components can range up to about 30% by volume of the liquid or gelled ammonia mixture. These components assist in rendering the mixture easier to pump and help in load recovery.

Further, although the ammonia fracturing formulation mixture is typically anhydrous, if desired it can include salt water (ex: KCl, CaCl, NaCl) in an amount sufficient to assist in transporting of the mixture and up to an amount of not more than 45% by weight.

While the disclosure has been provided and illustrated in connection with a specific embodiment, many variations and modifications may be made without departing from the spirit and scope of the invention(s) disclosed herein. The disclosure and invention(s) are therefore not to be limited to the exact components or details of methodology or construction set forth above. Except to the extent necessary or inherent in the methods themselves, no particular order to steps or stages of methods described in this disclosure, including the Figures, is intended or implied. In many cases the order of method steps may be varied without changing the purpose, effect, or import of the methods described. The scope of the claims is to be defined solely by the appended claims, giving due consideration to the doctrine of equivalents and related doctrines.

What is claimed is:

1. A fracturing fluid comprising liquid ammonia below the critical temperature of ammonia and a proppant.

2. The fracturing fluid of claim 1 wherein the liquid ammonia comprises at least about 25% by weight of the fracturing fluid.

3. The fracturing fluid of claim 2 further comprising a gelling agent which mixes with the liquid ammonia to form gelled ammonia.

4. The fracturing fluid of claim 3 further comprising a surfactant.

5. The fracturing fluid of claim 1 wherein the proppant is present in an amount and size sufficient to help maintain or keep an induced hydraulic fracture open during or following a fracturing treatment of an underground formation, and wherein ammonium hydroxide released from the liquid ammonia helps stabilize clays in the underground formation.

6. The fracturing fluid of claim 3 wherein the gelled ammonia is anhydrous and the proppant is an inorganic particulate material present in an amount of at least 3% by weight of the fracturing fluid.

7. The fracturing fluid of claim 6 wherein the inorganic particulate material is sand.

8. The fracturing fluid of claim 6 wherein the inorganic particulate material is ceramic.

9. The fracturing fluid of claim 2, wherein the gelled ammonia is present in an amount of between about 25% to 96% by weight of the fracturing fluid and the proppant is present in an amount between about 3% to 70% by weight of the fracturing fluid.

10. The fracturing fluid of claim 3 wherein the gelling agent comprises a clay in an amount up to about 500 pounds per thousand gallons of the fracturing fluid.

11. The fracturing fluid of claim 1 further comprising one or more additives selected from the group consisting of emulsion breakers, antifoams, scale inhibitors, hydrogen sulfide or oxygen scavengers, crosslinking agents, surface tension reducers, breakers, buffers, fluid loss additives, temperature stabilizers, diverting agents, paraffin/asphaltene inhibitors, corrosion inhibitors, or biocides.

12. The fracturing fluid of claim 2 further comprising a crosslinking agent.

13. A method for fracturing an underground formation which comprises:
providing a source of liquid ammonia;
providing a source of a proppant;
moving the liquid ammonia and proppant to a blender;
mixing the liquid ammonia and a proppant in the blender;
pumping the combined liquid ammonia and proppant into the underground formation at a pressure and rate sufficient to fracture the formation.

14. The method of claim 13 wherein the source of liquid ammonia is at least one storage tank wherein the liquid ammonia may be maintained below the critical temperature of ammonia.

15. The method of claim 13 further comprising the step of mixing a gelling agent with the liquid ammonia to create a gelled liquid ammonia having a viscosity between about 5 and about 300 cps.

16. The method of claim 14 further comprising the step of mixing a crosslinking agent to the gelled liquid ammonia.

17. The method of claim 13 wherein one or more additional components are added to the combined liquid ammonia and proppant, the one or more additional components selected from the group of emulsion breakers, antifoams, scale inhibitors, hydrogen sulfide or oxygen scavengers, crosslinking agents, surface tension reducers, breakers, buffers, fluid loss additives, temperature stabilizers, diverting agents, paraffin/asphaltene inhibitors, corrosion inhibitors, and biocidecontains.

18. The method of claim 17 wherein the liquid ammonia comprises at least 25% by weight of a total fracturing fluid.

19. The method of claim 17 wherein the proppant comprises about 3% to about 70% by weight of a total fracturing fluid.

20. A method for fracturing an underground formation which comprises:
providing a fracturing fluid comprising a liquid ammonia, a gelling agent, and a proppant; and
pumping the fracturing fluid into the underground formation to fracture the formation.

21. The method according to claim 20, wherein the gelling agent is a guar gum.

22. The method according to claim 20, wherein the fracturing fluid further comprises a surfactant.

23. The method according to claim 20, wherein the liquid ammonia is anhydrous and is present in an amount of at least 25% by weight of the fracturing fluid and the proppant is an inorganic particulate material present in an amount of at least 3% by weight of the fracturing fluid.

24. The method according to claim 23, wherein the liquid ammonia is present in an amount of between 25% to 96% by weight of the fracturing fluid and the proppant is present in an amount of at least 3% to 70% by weight of the fracturing fluid.

25. The method of claim 20, wherein the fracturing fluid contains a crosslinking agent.

26. A method for fracturing an underground formation which comprises:
pumping a fracturing fluid into a wellbore that extends to the formation, the fracturing fluid comprising liquid ammonia and a proppant;
generating pressure in the wellbore;
creating fractures in the formation; and
releasing pressure from the wellbore;
wherein ammonium hydroxide released from the liquid ammonia helps stabilize clays in the formation and the proppant helps to maintain the fractures in the formation.

27. The method according to claim 26, wherein the fracturing fluid contains a gelling agent.

28. The method according to claim 27, wherein the gelling agent comprises a polymer.

29. The method according to claim 27, wherein the gelling agent comprises a clay and a surfactant in an amount less than about 10% by weight of the fracturing fluid.

30. The method according to claim 26, wherein the fracturing fluid further comprises one or more additives selected from the group consisting of emulsion breakers, antifoams, scale inhibitors, hydrogen sulfide or oxygen scavengers, surface tension reducers, breakers, buffers, fluid loss additives, temperature stabilizers, diverting agents, paraffin/asphaltene inhibitors, corrosion inhibitors, or biocides.

31. A method of fracturing a formation within a well which comprises:
preparing a liquid ammonia component at surface, the liquid ammonia having sufficient viscosity to support a proppant;
mixing the proppant into the liquid ammonia component;
introducing the liquid ammonia and proppant mixture into a pressure pump and increasing a pump pressure;
pumping the mixture down the well at a sufficient pressure and a sufficient rate to fracture the formation.
